(19) United States
(12) Patent Application Publication
(10) Pub. No.: US 2013/0254812 A1
(43) Pub. Date: Sep. 26, 2013

(54) IPTV RADIO DEVICE USING LOW-BANDWIDTH CONNECTION

(71) Applicants: Charles McCoy, Coronado, CA (US); Leo Mark Pedlow, JR., Ramona, CA (US); Jason Wallace, Encinitas, CA (US); True Xiong, San Diego, CA (US)

(72) Inventors: Charles McCoy, Coronado, CA (US); Leo Mark Pedlow, JR., Ramona, CA (US); Jason Wallace, Encinitas, CA (US); True Xiong, San Diego, CA (US)

(73) Assignees: SONY NETWORK ENTERTAINMENT INTERNATIONAL LLC, Los Angeles, CA (US); SONY CORPORATION, Tokyo (JP)

(21) Appl. No.: 13/429,166

(22) Filed: Mar. 23, 2012

(51) Int. Cl. H04N 21/60; H04N 21/482

(52) U.S. Cl. 725/59

(57) ABSTRACT

Providing audio services to an Internet television device using a low-bandwidth Internet connection, including: configuring the Internet television device to operate and receive audio services using a low-bandwidth Internet connection; presenting a list of authorized services on a display of the Internet television device; receiving a search word for desired services, searching using the search word and aggregating search results, and presenting a playlist of services and stations obtained from the search results based on user's playback history and device's modular capabilities, when the desired services are not in the list of authorized or recommended services; enabling a customer to select a service from the list of authorized services or playlist of services and stations; and generating and streaming audio portion of the selected service to the Internet television device. Keywords include IPTV and low-bandwidth.

### BACKGROUND

1. Field of the Invention

The present invention relates to an IPTV radio device, and more specifically, to the IPTV radio device targeting a low-bandwidth area.

2. Background

The Internet as a global network for delivery of content is increasing in popularity due to a number of technical advancements in broadband Internet connectivity such as 3G and 4G, which creates both opportunities and challenges to content and service providers. Marketing research shows that the growth of Internet television (e.g., Internet Protocol television (IPTV)) will be in the developing countries such as China and India. However, network infrastructures in these developing countries are limited and undeveloped, and are unable to deliver quality content that require high bandwidth to customers.

### SUMMARY

In one implementation, a method of providing audio services to an Internet television device using a low-bandwidth Internet connection is disclosed. The method includes: configuring the Internet television device to operate and receive audio services using a low-bandwidth Internet connection; presenting a list of authorized services on a display of the Internet television device; receiving a search word for desired services, searching using the search word and aggregating search results, and presenting a playlist of services and stations obtained from the search results based on user's playback history and device's modular capabilities, when the desired services are not in the list of authorized or recommended services; enabling a customer to select a service from the list of authorized services or playlist of services and stations; and generating and streaming audio portion of the selected service to the Internet television device.

In another implementation, a system of providing audio services to an Internet television device using a low-bandwidth Internet connection is disclosed. The system includes: a processor configured to present a list of authorized services on a display of the Internet television device, the processor to receive a search word for desired services, search using the search word and aggregate search results, and present a playlist of services and stations obtained from the search results, when the desired services are not in the list of authorized services, wherein a customer using the Internet television device is enabled to select a service from the list of authorized services or playlist of services and stations; a content and service converter configured to generate audio portion of the selected service; and a streaming unit configured to stream the generated audio portion to the Internet television device.

In another implementation, a non-transitory storage medium storing a computer program to provide audio services to an Internet television device using a low-bandwidth Internet connection is disclosed. The computer program includes executable instructions that cause a computer to: present a list of authorized or recommended services on a display of the Internet television device; receive a search word for desired services, search using the search word and aggregate search results, and present a playlist of services and stations obtained from the search results, when the desired services are not in the list of authorized or recommended services; enable a customer to select a service from the list of recommended services or playlist of services and stations; and generate and stream audio portion of the selected service to the Internet television device.

Other features and advantages of the present invention will become more readily apparent to those of ordinary skill in the art after reviewing the following detailed description and accompanying drawings.

### BRIEF DESCRIPTION OF THE DRAWINGS

FIG. 1 is a functional block diagram of a server including a content and service converter in accordance with one implementation of the present invention.

FIG. 2 is a flowchart illustrating a method of providing audio services to an IPTV radio device using a low-bandwidth Internet connection in accordance with one implementation of the present invention.

FIG. 3A illustrates a representation of a computer system and a user.

FIG. 3B is a functional block diagram illustrating the computer system hosting a low bandwidth (LBW) streaming service.

### DETAILED DESCRIPTION

Certain implementations as disclosed herein describe apparatus, methods, and systems for an Internet Protocol television (IPTV) device targeting the low-bandwidth area. After reading this description it will become apparent how to implement the invention in various implementations and applications. Although various implementations of the present invention will be described herein, it is understood that these implementations are presented by way of example only, and not limitation. As such, this detailed description of various implementations should not be construed to limit the scope or breadth of the present invention.

As described above, marketing research shows that the IPTV will grow most in popularity in the developing countries such as China and India. However, network infrastructures in these developing countries are limited and undeveloped, and are unable to deliver quality content that require high bandwidth to customers. Accordingly, an IPTV device configured to target the bandwidth range that is supported by these developing countries can be desirable.

In one implementation, an IPTV radio device is configured to target the bandwidth range that is supported by the developing countries so that it can appeal to the local consumers. The IPTV radio device is configured to target low bandwidth areas where the delivery of high resolution video is not possible. As an example, an average bandwidth in China and India is between 0.8 to 1 Mbits/sec, whereas an average bandwidth needed to play a high-definition movie is 6 Mbits/sec. Thus, the IPTV radio device is configured as a modular, low-bandwidth audio device featuring, for example, a small display/user interface of three text lines. The radio can also communicate via the customer's low bandwidth Internet connection to retrieve local, regional, and worldwide services including streaming and on-demand services such as the Bravia Internet Video Link (BIVL) system. In the case of this low-bandwidth IPTV radio device, the streaming and on-demand services are geared toward audio and text-to-speech services.

To create a customer loyalty experience, the product is built modular. Thus, hardware modules can be added to the hardware platform system as new features become available. For example, when a Voice-over-IP (VoIP) service is introduced to the IPTV radio, a customer only needs to buy a compatible microphone and update the radio's firmware to recognize the microphone's driver. That is, the customer can enjoy new features without having to purchase a new IPTV radio device.

The IPTV radio device allows customers in the developing countries to listen to a broad range of Internet radio stations, audio portions of the television stations, and converted text-to-speech of the print services using the low bandwidth Internet connection. The radio software allows the customers to favorite their radio stations/audio services; create their own stations in their own language (virtually unlimited); and receive recommended or featured radio stations/audio services through the current search and recommendation system of the streaming and on-demand services. In countries such as India and China, there are many languages and dialects spoken, so a customized language has a significant appeal.

In one implementation, the starter audio service package of the IPTV radio device can be provided for free with or without advertising supported. However, premium audio services can be introduced later based on demand. For example, in India, a sport audio service package for cricket can be offered as a premium audio service available on the IPTV radio device.

In another implementation, a method of using the IPTV radio device to target the low-bandwidth area for audio services is described. The method includes turning on the IPTV radio and connecting the radio device to the Internet. Once the radio device is connected to the Internet, it launches a streaming and on-demand service (hereinafter referred to as “the BIVL service”) such as the BIVL system. In response, a list of authorized services is returned and displayed to the customer on a simple 3-line user interface in the local language. In one implementation, an authorized service is a service for which the BIVL service has an existing relationship with that service's provider and the device has authenticated credentials to access it. The list of services can include recommended or featured services from radio stations, television stations, and print services. The customer then selects a service to listen to from the list of authorized services.

The BIVL service provides the service selected by the customer (from the list of authorized services) differently depending on the type of service selected. That is, if the customer has selected a radio station, the BIVL service streams or downloads the broadcast of the radio station. If the customer has selected a television station, the BIVL service streams or downloads the audio portion of the television broadcast. In one implementation, to extract the audio portion of the television broadcast, the BIVL service can separate the audio track from one or more video content in near real-time. In another implementation, to extract the audio portion of the television broadcast, the BIVL service can separate the audio track from one or more video content at a scheduled time. In another implementation, the audio track may already be available in a separate file. Thus, the BIVL service can just provide the online address (e.g., URN or URL) of the audio track to the IPTV radio device. The BIVL service can also provide a subtitle track in a specific language, since the video content usually contains the subtitle track. In a further implementation, the audio portion is generated by extracting the audio portion from a television broadcast in near real-time or at schedule time, e.g. 7 AM for Morning News. Otherwise, if the customer has selected a print service (e.g., a newspaper or magazine), the BIVL service first converts the text of the print service to speech in near real-time, and streams or downloads the speech to the IPTV radio device. Furthermore, if the customer has selected a print service (e.g., a newspaper or magazine), the BIVL service first converts the text of the print service to speech at a scheduled time, and streams or downloads the speech to the IPTV radio device.

In addition or as an alternative to the authorized services, the BIVL service also enables the customer to search for services entering a search word (e.g., “cricket” to find services and stations that provide cricket games) into a search and recommendation system of the BIVL service. The BIVL service aggregates all data matching the search word in that region/country and creates a playlist of services and stations based on the user's playback history and modular device capabilities, e.g., compatible microphone, local-networked speakers, etc.

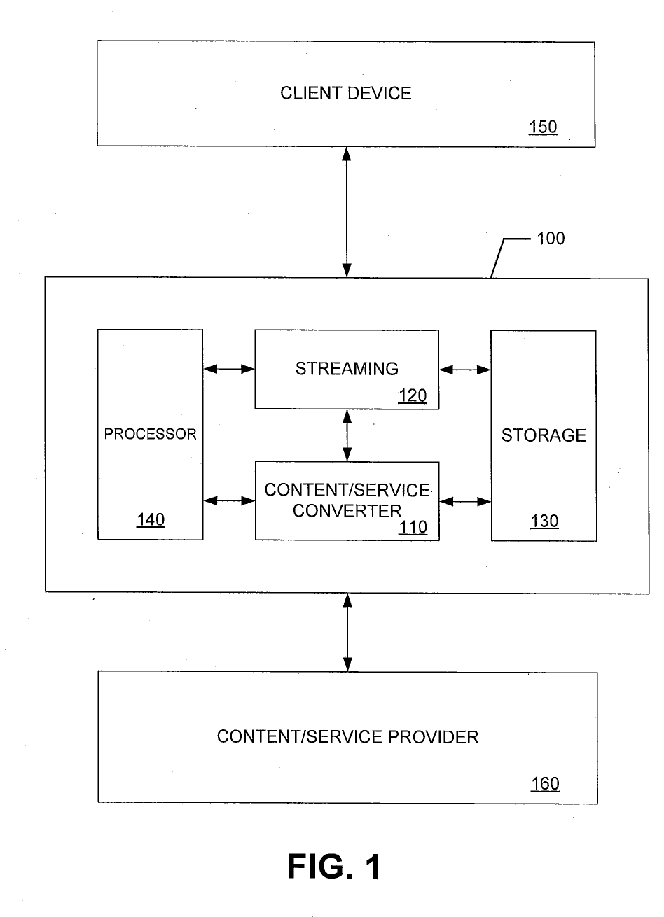

FIG. 1 is a functional block diagram of a server 100 including a content and service converter 110 in accordance with one implementation of the present invention. In the illustrated implementation of FIG. 1, the server 100, which is in communication with a client device 150 and a content and service provider 160, also includes a processor 140, a streaming unit 120, and storage 130. In one implementation, the server 100 is configured as the BIVL service to provide streaming and on-demand services accessible through a client device. The client device 150 can be configured as the IPTV radio device which enables customers in the developing countries to listen to a broad range of Internet radio stations, audio portions of the television stations, and converted text-to-speech of the print services using the low bandwidth Internet connection.

The server 100 provides the service selected by the client device 150 differently depending on the type of service selected. That is, if the client device 150 selects a radio station, the processor 140 of the server 100 streams or downloads the broadcast of the radio station. If the client device 150 selects a television station, the content/service converter 110 of the server 100 extracts the audio portion of the television broadcast by separating the audio track from one or more video content. The separated audio portion is then sent to the streaming unit 120 to be streamed or downloaded to the client device 150. In case the audio track is available in a separate file, that file can be streamed or downloaded by the streaming unit 120, or the server 100 may provide the online address of the file to the client device 150. The server 100 can also provide a subtitle track in a specific language to the client device 150, since the video content usually contains the subtitle track. Otherwise, if the client device 150 has selected a print service (e.g., a newspaper or magazine), the content/service converter 110 first converts the text of the print service to speech, and sends the speech to the streaming unit 120 for streaming or downloading to the client device 150.

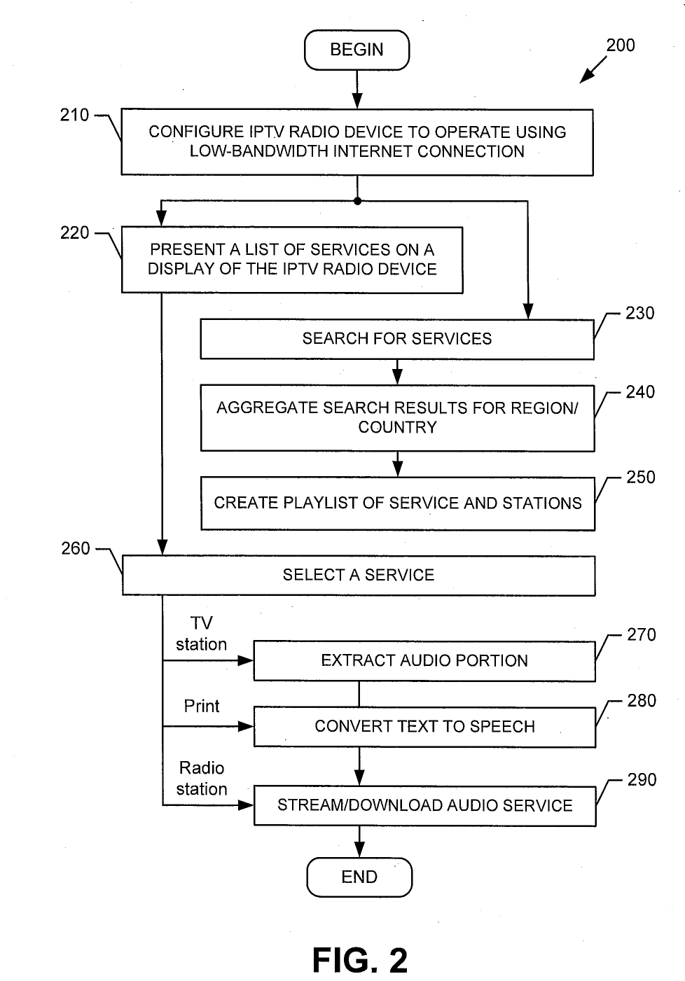

FIG. 2 is a flowchart 200 illustrating a method of providing audio services to an IPTV radio device using a low-bandwidth Internet connection in accordance with one implementation of the present invention. The IPTV radio device is configured, at box 210, to operate and receive audio services using a low-bandwidth Internet connection. In practice, the IPTV radio device is configured to operate within the bandwidth range that is supported by the developing countries where the delivery of high resolution video is not possible. Thus, the IPTV radio device is configured as a modular, low-bandwidth audio device featuring, for example, a small display/user interface of three text lines. The IPTV radio device allows customers in the developing countries to listen to a broad range of Internet radio stations, audio portions of the television stations, and converted text-to-speech of the print services using the low bandwidth Internet connection.

Once the IPTV radio device is connected to the Internet through the low-bandwidth connection, a list of authorized services is presented, at box 220, on a display of the IPTV radio device. The list of authorized services can include recommended or featured services from radio stations, television stations, and print services. In addition or as an alternative to presenting a list of recommended services, a customer is enabled to search for services by entering a search word into the IPTV radio device, at box 230. Search results matching the search word in that region/country are then aggregated, at box 240, and a playlist of services and stations is created, at box 250. The customer then selects a service, at box 260, from the list of authorized services or the playlist.

If the customer selects a television station, at box 260, audio portion of the television broadcast is extracted in near real-time, at box 270. If the customer selects a print service (e.g., a newspaper or magazine), the text of the print service is converted in near real-time, at box 280, to speech. The audio service is then streamed or downloaded, at box 290.

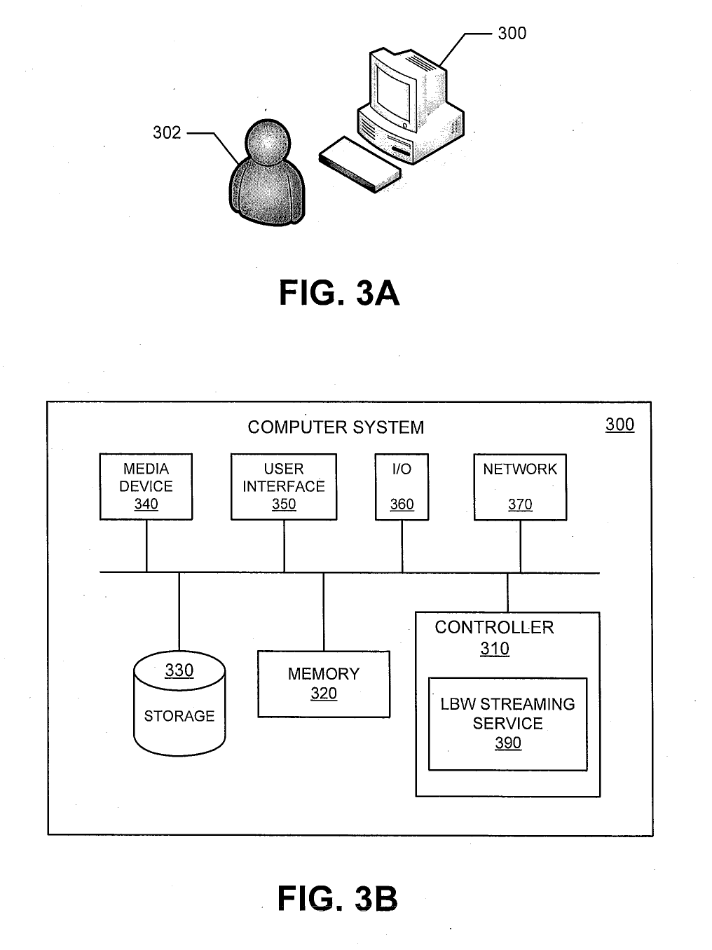

FIG. 3A illustrates a representation of a computer system 300 and a user 302. In one implementation, the computer system can be configured as a server (e.g., reference 100 in FIG. 1) to provide the BIVL service to an IPTV radio device.

FIG. 3B is a functional block diagram illustrating the computer system 300 hosting a low bandwidth (LBW) streaming service 390. The controller 310 is a programmable processor and controls the operation of the computer system 300 and its components. The controller 310 loads instructions (e.g., in the form of a computer program) from the memory 320 or an embedded controller memory (not shown) and executes these instructions to control the system. In its execution, the controller 310 provides the low bandwidth (LBW) streaming service 390 as a software system (running on the server 100 of FIG. 1). Alternatively, this service can be implemented as separate hardware components in the controller 310 or the computer system 300.

Memory 320 stores data temporarily for use by the other components of the computer system 300. In one implementation, memory 320 is implemented as RAM. In one implementation, memory 320 also includes long-term or permanent memory, such as flash memory and/or ROM.

Non-transitory storage 330 stores data for use by other components of the computer system 300, such as for storing data used by the low bandwidth (LBW) streaming service 390. In one implementation, storage 330 is a hard disk drive.

The media device 340 receives removable media and reads and/or writes data to the inserted media. In one implementation, for example, the media device 340 is an optical disc drive.

The user interface 350 includes components for accepting user input from the user 302 and presenting information to the user 302. In one implementation, the user interface 350 includes a keyboard, a mouse, audio speakers, and a display. The controller 310 uses input from the user 302 to adjust the operation of the computer system 300.

The I/O interface 360 includes one or more I/O ports to connect to corresponding I/O devices, such as external storage or supplemental devices (e.g., a printer or a PDA). In one implementation, the ports of the I/O interface 360 include ports such as: USB ports, PCMCIA ports, serial ports, and/or parallel ports. In another implementation, the I/O interface 360 includes a wireless interface for communication with external devices wirelessly.

The network interface 370 includes a wired and/or wireless network connection, such as an RJ-45 or “Wi-Fi” interface (including, but not limited to 302.11) supporting an Ethernet connection.

The computer system 300 includes additional hardware and software typical of computer systems (e.g., power, cooling, operating system), though these components are not specifically shown in FIG. 3B for simplicity. In other implementations, different configurations of the computer system can be used (e.g., different bus or storage configurations or a multi-processor configuration).

The above description of the disclosed implementations is provided to enable any person skilled in the art to make or use the invention. Various modifications to these implementations will be readily apparent to those skilled in the art, and the generic principles described herein can be applied to other implementations without departing from the spirit or scope of the invention. Accordingly, additional implementations and variations are also within the scope of the invention. For example, although the specification focuses on x, x. Further, it is to be understood that the description and drawings presented herein are representative of the subject matter which is broadly contemplated by the present invention. It is further understood that the scope of the present invention fully encompasses other implementations that may become obvious to those skilled in the art and that the scope of the present invention is accordingly limited by nothing other than the appended claims.

1. A method of providing audio services to an Internet television device using a low-bandwidth Internet connection, the method comprising:
configuring the Internet television device to operate and receive audio services using a low-bandwidth Internet connection;
presenting a list of authorized services on a display of the Internet television device;
receiving a search word for desired services, searching using the search word and aggregating search results, and presenting a playlist of services and stations obtained from the search results based on user's playback history and device's modular capabilities, when the desired services are not in the list of authorized or recommended services;
enabling a customer to select a service from the list of authorized services or playlist of services and stations; and
generating and streaming audio portion of the selected service to the Internet television device.

2. The method of claim 1, wherein the audio portion is generated by extracting the audio portion from a television broadcast in near real-time or at scheduled time.

3. The method of claim 2, wherein extracting the audio portion from a television broadcast comprises
enabling the Internet television device to retrieve the audio portion from a separate file.

4. The method of claim 3, wherein enabling the Internet television device to retrieve the audio portion from a separate file comprises
providing an online address of the separate file.

5. The method of claim 1, wherein the audio portion is generated by converting text from a print service to speech in near real-time or at scheduled time.

6. The method of claim 1, wherein the Internet television device is an IPTV radio device.

7. The method of claim 1, wherein configuring the Internet television device comprises
configuring the Internet television device as a modular device.

8. The method of claim 1, wherein configuring the Internet television device comprises
enabling the Internet television device to present to the customer a broad range of Internet radio stations, audio portions of the television stations, and converted text-to-speech of the print services.

9. The method of claim 1, wherein aggregating search results comprises
aggregating search results for a region or country where the Internet television is located.

10. The method of claim 1, further comprising
providing a subtitle track in a language commonly used in the region or country where the Internet television is located.

11. A system of providing audio services to an Internet television device using a low-bandwidth Internet connection, the system comprising:
a processor configured to present a list of authorized services on a display of the Internet television device, the processor to receive a search word for desired services, search using the search word and aggregate search results, and present a playlist of services and stations obtained from the search results, when the desired services are not in the list of authorized services,
wherein a customer using the Internet television device is enabled to select a service from the list of authorized services or playlist of services and stations;
a content and service converter configured to generate audio portion of the selected service; and
a streaming unit configured to stream the generated audio portion to the Internet television device.

12. The system of claim 11, wherein the system is configured as a streaming and on-demand service accessible through the Internet television device.

13. The system of claim 11, wherein the content and service converter includes an extractor configured to extract the audio portion from a television broadcast.

14. The system of claim 11, wherein the content and service converter converts text from a print service to speech to generate the audio portion.

15. The system of claim 11, wherein the Internet television device is an IPTV radio device.

16. The system of claim 11, wherein the Internet television device is a modular device.

17. A non-transitory storage medium storing a computer program to provide audio services to an Internet television device using a low-bandwidth Internet connection, the computer program comprising executable instructions that cause a computer to:
present a list of recommended services on a display of the Internet television device;
receive a search word for desired services, search using the search word and aggregate search results, and present a playlist of services and stations obtained from the search results, when the desired services are not in the list of recommended services;
enable a customer to select a service from the list of recommended services or playlist of services and stations; and
generate and stream audio portion of the selected service to the Internet television device.

18. The non-transitory storage medium of claim 17, wherein executable instructions that cause a computer to generate audio portion comprise executable instructions that cause a computer to
extract the audio portion from a television broadcast.

19. The non-transitory storage medium of claim 17, wherein executable instructions that cause a computer to generate audio portion comprise executable instructions that cause a computer to
convert text from a print service to speech.

20. The non-transitory storage medium of claim 17, wherein executable instructions that cause a computer to aggregating search results comprise executable instructions that cause a computer to
aggregate search results for a region or country where the Internet television is located.
